(19) United States
(12) Patent Application Publication
(10) Pub. No.: US 2022/0307198 A1
(43) Pub. Date: Sep. 29, 2022

(54) VOLATILE FATTY ACID CONTROL

(71) Applicant: ECOLAB USA INC., St. Paul, MN (US)

(72) Inventor: Herman Mark Grimm, Stanley, NC (US)

(73) Assignee: ECOLAB USA INC., St. Paul, MN (US)

(21) Appl. No.: 17/632,625

(22) PCT Filed: Mar. 4, 2021
(86) PCT No.: PCT/US2020/044174

§ 371 Date: Feb. 3, 2022

Related U.S. Application Data
(60) Provisional application No. 62/894,350, filed on Aug. 30, 2019.

(51) Int. Cl. D21C 11/00; C02F 1/68; C02F 1/50; D21C 9/08

(52) U.S. Cl. CPC D21C 11/00; C02F 1/683; C02F 1/50; D21C 9/083; C02F 2101/34

(57) ABSTRACT

The present disclosure provides compositions and methods for treating volatile fatty acids and bacteria capable of producing volatile fatty acids. The compositions can convert acid-producing bacteria environments to nitrate-reducing bacteria environments. The compositions and methods can lower the amount of acid-producing bacteria present in the environment and thereby reduce the amount of volatile fatty acids present in the environment. The control agent may also inhibit the growth of acid-producing bacteria and volatile fatty acid concentrations. The compositions and methods can be used with any aqueous industrial system.

### BACKGROUND

### 1. Field of the Invention

The present disclosure generally relates to controlling volatile fatty acids (VFA) and/or bacteria capable of producing VFA in aqueous industrial systems.

### 2. Description of the Related Art

Papermaking slurries often contain sulfite. In some instances, the sulfite may be derived from a bleaching process or it may have been added intentionally to deactivate oxidizing biocides prior to dye addition. Broke chests are a frequent problem area for microbial control in papermaking systems and non-oxidizing biocides are frequently added to gain control. Broke slurries may contain high concentrations of facultative anaerobes as a result of poor microbial control. These anaerobes produce odorous fatty acid fermentation products, i.e., VFA, which can impart undesirable odors and produce dangerous concentrations of organic gases.

### BRIEF SUMMARY

The present disclosure provides compositions and methods for controlling VFA and/or bacteria capable of producing VFA. In some embodiments, methods are disclosed for controlling a VFA in an aqueous industrial system. The method may comprise adding an effective amount of a control agent to the aqueous industrial system, wherein the control agent is selected from the group consisting of a chelant, sodium bisulfite, and any combination thereof.

In some embodiments, the VFA may be selected from the group consisting of formic acid, acetic acid, butyric acid, propionic acid, isobutyric acid, valeric acid, isovaleric acid, and any combination thereof.

In some embodiments, a paper mill comprises the aqueous industrial system. The control agent may be added to a stream selected from the group consisting of a pulp slurry, a process water, a shower water, a thick stock, and any combination thereof. The control agent may also be added to a location selected from the group consisting of a water clarifier inlet, a water clarifier outlet, a stock tank, a machine chest, a head box inlet stream, a recovered stock tank, a machine water tank, a save all, and any combination thereof.

The paper mill may be a recycled packaging paper mill. The paper mill may comprise a closed water loop and the control agent may be added to process water in the closed water loop.

In some embodiments, the aqueous industrial system comprises wastewater or papermaking process water.

In some embodiments, the aqueous industrial system comprises an amount of a VFA-producing bacteria prior to addition of the control agent and the control agent reduces the amount of the VFA-producing bacteria in the aqueous industrial system as compared to the same aqueous industrial system that has not been treated with the control agent. In some embodiments, the VFA is produced by a bacteria.

In certain embodiments, the control agent inhibits the formation of the VFA in the aqueous industrial system as compared to an aqueous industrial system that was not treated with the control agent, and the VFA is selected from the group consisting of formic acid, acetic acid, butyric acid, propionic acid, isobutyric acid, valeric acid, isovaleric acid, and any combination thereof.

In some embodiments, the formation of the VFA is inhibited by at least 100%.

In some embodiments, the chelant is selected from the group consisting of ethylenediamine, ethylenediamine tetraacetic acid (EDTA), a porphyrin, a porphine derivative, diethylene-triamine-pentaacetic acid (DTPA), ethylene glycol bis(2-aminoethyl ether)-N,N,N′,N′-tetraacetic acid (EGTA), diethylenetriaminepentaacetic acid (DTPA), N-(2-Hydroxyethyl) ethylene diamine-N,N′,N′-triacetic acid (HEDTA), polyacrylic acid (PAA), boric acid (BA), sodium tripolyphosphate (STP), an alkoxyacetic acid, trimercaptotriazine, potassium thiocarbonate, sodium thiocarbonate, a dithiocarbamate, and any combination thereof.

The effective amount of the control agent may be from, for example, about 50 ppm to about 5,000 ppm or from about 100 ppm to about 1,000 ppm.

In some embodiments, an aqueous solution comprises from about 1% to about 99.9%, by weight, of the control agent. The aqueous solution may comprise from about 25% to about 45%, by weight, of the control agent. The aqueous solution may comprise greater than 50% by weight of the control agent.

In some embodiments, the control agent consists essentially of sodium bisulfite, a chelant, or a mixture thereof.

Still further, the present disclosure provides methods for reducing an amount of a VFA-producing bacteria in an aqueous industrial system. The methods may comprise adding an effective amount of a control agent to the aqueous industrial system, wherein the control agent is selected from the group consisting of a chelant, sodium bisulfite, and any combination thereof. The methods also include the step of binding a metal ion of the VFA-producing bacteria with the control agent. For example, the control agent may bind, chelate, form a complex with, etc., a metal ion in the cell and/or the cell wall. This will damage or destroy the cell, thereby preventing it from producing any additional VFA.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

Various embodiments are described below. However, embodiments are not limited to those explicitly described herein and may include, for example, derivatives, variations, and/or modifications of specific embodiments described herein.

In some embodiments, the present disclosure provides methods for converting rich bacteria environments from acid-producing bacteria environments to nitrate-reducing bacteria environments. These environments may be found, for example, in industrial process water. The inventor determined that the addition of a control agent to the process water can reduce the amount of the acid-producing bacteria and/or inhibit the growth of the acid-producing bacteria. The inventor determined that by adding a control agent to the water, the acid-producing bacteria may be eliminated or substantially eliminated. By reducing, inhibiting the growth of, eliminating, or substantially eliminating the acid-producing bacteria, the control agent also reduces, inhibits the growth of, eliminates, or substantially eliminates the VFA in the process water. The inventive process may also reduce, inhibit the growth of, eliminate, or substantially eliminate VFA in any product, such as paper, made from the industrial process.

The cell walls of bacteria may contain anionic lipids whose negative charges are shielded/bridged by divalent cations, such as calcium and magnesium. Without wishing to be bound by theory, the present inventor considers that chelating these metals with a control agent will destabilize the cell structure. For example, calcium plays an important role in connecting cell wall components in bacteria. Calcium is also involved in cell wall building. As such, if the calcium (and/or magnesium or other cell wall component) is chelated or otherwise complexed by or with the control agent, the bacteria will be unable to produce VFA. In some embodiments, the control agent may form a complex with the metal ions associated with the bacteria cells.

In accordance with the present disclosure, the term “volatile fatty acid” or “VFA” includes acids such as, but not limited to, formic acid, acetic acid, butyric acid, propionic acid, isobutyric acid, valeric acid, isovaleric acid, and any combination thereof. In some embodiments, the VFA is selected from the group consisting of acetic acid, butyric acid, and propionic acid. The methods of the present disclosure can reduce, inhibit the growth of, eliminate, or substantially eliminate any or all VFA in process water by utilizing the control agent.

In some embodiments, the control agent comprises, consists of, or consists essentially of sodium bisulfite. In accordance with the present disclosure, the phrases “consist essentially of,” “consists essentially of,” “consisting essentially of,” and the like limit the scope of a claim to the specified materials or steps and those materials or steps that do not materially affect the basic and novel characteristic(s) of the claimed invention.

If a control agent consists essentially of sodium bisulfite, some examples of components that would, in some embodiments, be considered to materially affect the basic and novel characteristics of the claimed invention include biocides, fountain solutions (or certain components thereof), coating compositions/solutions (or certain components thereof), vinyl polymers, dispersable polymers, water-soluble polymers, waxes, pH buffering agents such as organic and inorganic acids or salts thereof, surfactants, chlorite salts, chlorate salts, and enzymes. Illustrative, non-limiting examples of components that would not be considered to materially affect the basic and novel characteristics of the claimed invention include a chelant and/or water.

In some embodiments, the effective amount of control agent added to the process water may be selected to ensure that the process water contains from about 50 ppm to about 5,000 ppm of sodium bisulfite. For example, an effective amount of the sodium bisulfite in the process water may be from about 100 ppm to about 1,000 ppm, from about 100 ppm to about 500 ppm, from about 100 ppm to about 300 ppm, from about 200 ppm to about 500 ppm, from about 300 ppm to about 500 ppm, from about 500 ppm to about 1,000 ppm, any other sub-range between about 50 ppm and about 5,000 ppm, or any other amount determined to be effective to reduce, eliminate, or substantially eliminate VFA.

In some embodiments, the control agent comprises, consists of, or consists essentially of a chelant. If a control agent consists essentially of a chelant, some examples of components that would, in some embodiments, be considered to materially affect the basic and novel characteristics of the claimed invention include biocides, fountain solutions (or certain components thereof), coating compositions/solutions (or certain components thereof), vinyl polymers, dispersable polymers, water-soluble polymers, waxes, pH buffering agents such as organic and inorganic acids or salts thereof, surfactants, chlorite salts, chlorate salts, and enzymes. Illustrative, non-limiting examples of components that would not be considered to materially affect the basic and novel characteristics of the claimed invention include additional chelants and/or water.

The chelant that may be used in accordance with the present disclosure is not particularly limited, so long as it can bind and/or form a complex with metal ions. In some embodiments, the chelant is selected from the group consisting of an organic chelant, an inorganic chelant, and any combination thereof. In some embodiments, the chelant is selected from the group consisting of ethylenediamine, ethylenediamine tetraacetic acid (EDTA), a porphyrin, such as porphine or a porphine derivative, diethylene-triamine-pentaacetic acid (DTPA), ethylene glycol bis(2-aminoethyl ether)-N,N,N′,N′-tetraacetic acid (EGTA), diethylenetriaminepentaacetic acid (DTPA), N-(2-Hydroxyethyl) ethylene diamine-N,N′,N′-triacetic acid (HEDTA), polyacrylic acid (PAA), boric acid (BA), sodium tripolyphosphate (STP), an alkoxyacetic acid, trimercaptotriazine, potassium thiocarbonate, sodium thiocarbonate, a dithiocarbamate, and any combination thereof.

In certain embodiments, the chelant comprises, consists of, or consists essentially of EDTA, EGTA, or a combination thereof.

In some embodiments, the effective amount of control agent added to the process water may be selected to ensure that the process water contains from about 50 ppm to about 5,000 ppm of the chelant. For example, an effective amount of the chelant in the process water may be from about 100 ppm to about 1,000 ppm, from about 100 ppm to about 500 ppm, from about 100 ppm to about 300 ppm, from about 200 ppm to about 500 ppm, from about 300 ppm to about 500 ppm, from about 500 ppm to about 1,000 ppm, any other sub-range between about 50 ppm and about 5,000 ppm, or any other amount determined to be effective to reduce, eliminate, or substantially eliminate VFA.

In some embodiments, an aqueous solution comprises, consists of, or consists essentially of the control agent. In some embodiments, the aqueous solution comprises, consists of, or consists essentially of from about 1% to about 99.9%, by weight, of the control agent. In some embodiments, the aqueous solution comprises, consists of, or consists essentially of from about 1% to about 75%, from about 1% to about 50%, from about 1% to about 40%, from about 1% to about 30%, from about 1% to about 20%, or from about 1% to about 10%, by weight, of the control agent. In some embodiments, the aqueous solution comprises, consists of, or consists essentially of from about 10% to about 45%, from about 15% to about 45%, from about 20% to about 45%, or from about 25% to about 45%, by weight, of the control agent.

In some embodiments, the aqueous solution comprises, consists of, or consists essentially of more than 50% by weight of the control agent. For example, in some embodiments, the aqueous solution comprises, consists of, or consists essentially of more than about 55%, more than about 60%, or more than about 65%, by weight, of the control agent. In some embodiments, the aqueous solution comprises, consists of, or consists essentially of from about 55% to about 99.9%, from about 55% to about 90%, from about 55% to about 80%, from about 55% to about 70%, or from about 55% to about 60%, by weight, of the control agent.

The methods of the present disclosure may be used to control VFA in any aqueous environment/system. In some embodiments, the aqueous environment is an aqueous industrial system. The term “aqueous industrial system” refers to any system that circulates water as a primary ingredient. Non-limiting examples of “aqueous industrial systems” include cooling systems, boiler systems, heating systems, membrane systems, papermaking systems, or any other systems that circulate water. The inventive method can control VFA in any environment comprising bacteria capable of producing VFA. The inventive method can control VFA produced by bacteria.

In some embodiments, the presently disclosed control agent can inhibit formation of the VFA by at least 15%. For example, the control agent can inhibit formation of the VFA by greater than about 30%, greater than about 40%, greater than about 65%, greater than about 100%, or greater than about 200%. In some embodiments, the control agent inhibits formation of VFA by about 15% to greater than about 200%, by about 30% to greater than about 200%, by about 40% to greater than about 200%, by about 65% to greater than about 200%, or by about 100% to greater than about 200%.

In certain embodiments, the aqueous industrial system is papermaking process water. In certain embodiments, the aqueous industrial system is a wastewater stream.

In some embodiments, a paper mill comprises the aqueous industrial system. The paper mill may be, for example, a recycled packaging paper mill. In some embodiments, the paper mill has a closed water loop and the control agent is added to the process water in the closed water loop.

The control agent may be added at any location found throughout a papermaking process and/or to any stream found throughout a papermaking process. For example, the control agent may be added to the thick stock, the process water and/or to the pulp slurry. In some embodiments, the control agent may be added at any location in the wet end of the paper machine, such as in the forming section. Other locations for addition include, but are not limited to, the pulper, stock tank, machine chest, the head box inlet stream, the recovered stock tank, the machine water tank, the clarified water tank, and any combination thereof.

### Examples

Various samples of paper mill process water were obtained and added to 500 ml jars. The content of VFA in each sample was determined using an IC analyzer, which provides data regarding the concentration of various VFA contained in the sample. Then, each jar was either treated with a control agent in accordance with the present disclosure, a prior art biocide agent (glutaraldehyde), or nothing (blank). Each jar was then placed into an oven and heated to maintain a temperature of about 115 to 118° F. for the duration of the experiment. After certain time periods, such as after 24 hours, a sample was taken from each jar and injected into the IC analyzer to determine VFA content. The results are shown in Table I.

TABLE I

| Control Agent | Time | | IC Acetic | | IC Butyric | | IC Propionic | |
|---|---|---|---|---|---|---|---|---|
| Blank | 4 | hours | 867 | ppm | 60 | ppm | 85 | ppm |
| Glutaraldehyde | 4 | hours | 857 | ppm | 65 | ppm | 93 | ppm |
| 100 ppm | | | | | | | | |
| 40% Sodium | 4 | hours | 852 | ppm | 61 | ppm | 90 | ppm |
| Bisulfite 500 ppm | | | | | | | | |
| 27% Sodium | 4 | hours | 850 | ppm | 64 | ppm | 90 | ppm |
| Bisulfite 500 ppm | | | | | | | | |
| Blank | 24 | hours | 1123 | ppm | 121 | ppm | 128 | ppm |
| Glutaraldehyde | 24 | hours | 970 | ppm | 67 | ppm | 109 | ppm |
| 100 ppm | | | | | | | | |
| 40% Sodium | 24 | hours | 999 | ppm | 67 | ppm | 106 | ppm |
| Bisulfite 500 ppm | | | | | | | | |
| 27% Sodium | 24 | hours | 987 | ppm | 62 | ppm | 107 | ppm |
| Bisulfite 500 ppm | | | | | | | | |
| Blank | 48 | hours | 1591 | ppm | 188 | ppm | 174 | ppm |
| Glutaraldehyde | 48 | hours | 1206 | ppm | 87 | ppm | 136 | ppm |
| 100 ppm | | | | | | | | |
| 40% Sodium | 48 | hours | 1308 | ppm | 92 | ppm | 129 | ppm |
| Bisulfite 500 ppm | | | | | | | | |
| 27% Sodium | 48 | hours | 1210 | ppm | 68 | ppm | 125 | ppm |
| Bisulfite 500 ppm | | | | | | | | |

In Table 1, it can be seen that the control agents of the present application are capable of inhibiting growth of the VFA and/or reducing VFA concentration. For example, with respect to the “blank” trials, the concentration of butyric acid was at 60 ppm after 4 hours, 121 ppm after 24 hours, and 188 ppm after 48 hours. With respect to the 27% sodium bisulfite trials, the concentration of butyric acid was at 64 ppm after 4 hours, 62 ppm after 24 hours, and 68 ppm after 48 hours. As such, the sodium bisulfite inhibited the formation of VFA by more than 200%.

A similar experiment was conducted but this time EDTA was also tested as a control agent. Results are shown in Table 2.

TABLE 2

| Control Agent | Time | | IC Acetic | | IC Butyric | | IC Propionic | |
|---|---|---|---|---|---|---|---|---|
| Blank | 4 | hours | 623 | ppm | 54 | ppm | 51 | ppm |
| Glutaraldehyde | 4 | hours | 627 | ppm | 60 | ppm | 55 | ppm |
| 100 ppm | | | | | | | | |
| 27% Sodium | 4 | hours | 623 | ppm | 59 | ppm | 52 | ppm |
| Bisulfite 100 ppm | | | | | | | | |
| 27% Sodium | 4 | hours | 632 | ppm | 55 | ppm | 55 | ppm |
| Bisulfite 500 ppm | | | | | | | | |
| EDTA 500 ppm | 4 | hours | 632 | ppm | 59 | ppm | 53 | ppm |
| Blank | 24 | hours | 804 | ppm | 71 | ppm | 88 | ppm |
| Glutaraldehyde | 24 | hours | 702 | ppm | 56 | ppm | 61 | ppm |
| 100 ppm | | | | | | | | |
| 27% Sodium | 24 | hours | 798 | ppm | 69 | ppm | 70 | ppm |
| Bisulfite 100 ppm | | | | | | | | |
| 27% Sodium | 24 | hours | 724 | ppm | 49 | ppm | 62 | ppm |
| Bisulfite 500 ppm | | | | | | | | |
| EDTA 500 ppm | 24 | hours | 785 | ppm | 61 | ppm | 67 | ppm |
| Blank | 72 | hours | 1203 | ppm | 106 | ppm | 172 | ppm |
| Glutaraldehyde | 72 | hours | 860 | ppm | 66 | ppm | 77 | ppm |
| 100 ppm | | | | | | | | |
| 27% Sodium | 72 | hours | 1188 | ppm | 106 | ppm | 103 | ppm |
| Bisulfite 100 ppm | | | | | | | | |
| 27% Sodium | 72 | hours | 730 | ppm | 45 | ppm | 63 | ppm |
| Bisulfite 500 ppm | | | | | | | | |
| EDTA 500 ppm | 72 | hours | 1005 | ppm | 77 | ppm | 64 | ppm |

In Table 2, it can be seen that the control agents of the present application are capable of inhibiting growth of the VFA and/or reducing VFA concentration. For example, with respect to the “27% Sodium Bisulfite 500 ppm” trials, the concentration of butyric acid was at 55 ppm after 4 hours, 49 ppm after 24 hours, and 47 ppm after 72 hours.

In an additional experiment, a sample of process water was obtained and analyzed for acid-producing bacteria concentration. Microbiological identification was determined using a molecular approach that included DNA sequencing. It was determined that the sample contained about 13.5% acid-producing bacteria. To the sample was added about 900 ppm of 27% sodium bisulfite. The sample was analyzed again about 24 hours later and it was determined that the sample contained about 8.5% acid-producing bacteria. Thus, the amount of acid-producing bacteria was reduced by about 40% after addition of the control agent.

As can be seen, sodium bisulfite and EDTA have a significant effect on these rich bacteria environments. The sodium bisulfite control agents were applied as aqueous solutions containing about 27% or about 40%, by weight, of sodium bisulfite. Specifically, sodium bisulfite and EDTA have been shown to convert these environments from acid-producing bacteria environments to nitrate-reducing bacteria environments. By reducing, inhibiting growth of, eliminating, or substantially eliminating the acid-producing bacteria, the control agent also reduces, inhibits growth of, eliminates, or substantially eliminates the VFA. Both EDTA and sodium bisulfite displayed significant reduction/growth inhibition as compared to “blank.” The control agents were tested along with glutaraldehyde, which is the industry standard biocide used to control VFA.

Any composition disclosed herein may comprise, consist of, or consist essentially of any of the compounds/components disclosed herein. In accordance with the present disclosure, the phrases “consist essentially of,” “consists essentially of,” “consisting essentially of,” and the like limit the scope of a claim to the specified materials or steps and those materials or steps that do not materially affect the basic and novel characteristic(s) of the claimed invention.

As used herein, the term “about” refers to the cited value being within the errors arising from the standard deviation found in their respective testing measurements, and if those errors cannot be determined, then “about” refers to within 5% of the cited value.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

In addition, unless expressly stated to the contrary, use of the term “a” is intended to include “at least one” or “one or more.” For example, “a chelant” is intended to include “at least one chelant” or “one or more chelants.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

1. A method of controlling a volatile fatty acid in an aqueous industrial system, comprising:
adding an effective amount of a control agent to the aqueous industrial system, wherein the control agent is selected from the group consisting of a chelant, sodium bisulfate, and any combination thereof.

2. The method of claim 1, wherein the volatile fatty acid is selected from the group consisting of formic acid, acetic acid, butyric acid, propionic acid, isobutyric acid, valeric acid, isovaleric acid, and any combination thereof.

3. The method of claim 1, wherein a paper mill comprises the aqueous industrial system.

4. The method of claim 3, wherein the control agent is added to a stream selected from the group consisting of a pulp slurry, a process water, a shower water, a thick stock, and any combination thereof.

5. The method of claim 3, wherein the control agent is added to a location selected from the group consisting of a water clarifier inlet, a water clarifier outlet, a stock tank, a machine chest, a head box inlet stream, a recovered stock tank, a machine water tank, a save all, and any combination thereof.

6. The method of claim 3, wherein the paper mill is a recycled packaging paper mill.

7. The method of claim 3, wherein the paper mill comprises a closed water loop.

8. The method of claim 7, wherein the control agent is added to process water in the closed water loop.

9. The method of claim 1, wherein the aqueous industrial system comprises wastewater or papermaking process water.

10. The method of claim 1, wherein the aqueous industrial system comprises a volatile fatty acid-producing bacteria prior to addition of the control agent.

11. The method of claim 10, wherein the control agent reduces an amount of the volatile fatty acid-producing bacteria in the aqueous industrial system as compared to an aqueous industrial system that was not treated with the control agent.

12. The method of claim 10, wherein the control agent inhibits the formation of the volatile fatty acid in the aqueous industrial system as compared to an aqueous industrial system that was not treated with the control agent, and wherein the volatile fatty acid is selected from the group consisting of formic acid, acetic acid, butyric acid, propionic acid, isobutyric acid, valeric acid, isovaleric acid, and any combination thereof.

13. The method of claim 12, wherein the formation of the volatile fatty acid is inhibited by at least 100%.

14. The method of claim 1, wherein the volatile fatty acid is produced by a bacteria.

15. The method of claim 1, wherein the chelant is selected from the group consisting of ethylenediamine, ethylenediamine tetraacetic acid (EDTA), a porphyrin, a porphine derivative, diethylene-triamine-pentaacetic acid (DTPA), ethylene glycol bis(2-aminoethyl ether)-N,N,N′,N′-tetraacetic acid (EGTA), diethylenetriaminepentaacetic acid (DTPA), N-(2-Hydroxyethyl) ethylene diamine-N,N′,N′-triacetic acid (HEDTA), polyacrylic acid (PAA), boric acid (BA), sodium tripolyphosphate (STP), an alkoxyacetic acid, trimercaptotriazine, potassium thiocarbonate, sodium thiocarbonate, a dithiocarbamate, and any combination thereof.

16. The method of claim 1, wherein the effective amount is from about 50 ppm to about 5,000 ppm.

17. (canceled)

18. The method of claim 1, wherein an aqueous solution comprises from about 1% to about 99.9%, by weight, of the control agent.

19. (canceled)

20. (canceled)

21. The method of claim 1, wherein the control agent consists essentially of sodium bisulfate, a chelant, or a mixture thereof.

22. A method of reducing an amount of a volatile fatty acid-producing bacteria in an aqueous industrial system, comprising:
adding an effective amount of a control agent to the aqueous industrial system, wherein the control agent is selected from the group consisting of a chelant, sodium bisulfate, and any combination thereof, and
binding a metal ion of the volatile fatty acid-producing bacteria with the control agent.

23. The method of claim 22, wherein a paper mill comprises the aqueous industrial system.
